(19) United States
(12) Patent Application Publication
(10) Pub. No.: US 2014/0040791 A1
(43) Pub. Date: Feb. 6, 2014

(54) DEVELOPMENT PLATFORM FOR SOFTWARE AS A SERVICE (SAAS) IN A MULTI-TENANT ENVIRONMENT

(71) Applicant: LG CNS CO., LTD., (US)

(72) Inventors: Hyun Jun Kim, Seoul (KR); Sang Mi Choi, Seoul (KR); Hwan Joon Choi, Gyeonggi-do (KR); Eun Hwa Lee, Gyeonggi-do (KR); Kyung In Kang, Seoul (KR); Sang Ok Song, Gyeonggi-do (KR); Hang Seub Lim, Gyeonggi-do (KR)

(73) Assignee: LG CNS CO., LTD., Seoul (KR)

(21) Appl. No.: 13/759,263

(22) Filed: Feb. 5, 2013

(30) Foreign Application Priority Data
Mar. 29, 2012 (KR) 10-2012-0032714

(51) Int. Cl. G06F 3/048

(52) U.S. Cl. CPC G06F 3/048
USPC 715/762

(57) ABSTRACT

Embodiments of the present invention relate to software as a service (SaaS) development in a multi-tenant environment. Specifically, a platform for software as a service (SaaS) application development and customization in a multi-tenant environment is provided. An interface template is defined based on application metadata. Application metadata may comprise and/or be based upon tenant metadata (e.g., via transformation). A desired graphical user interface is rendered based on the interface template. The desired graphical user interface may be edited by the tenant. An SaaS application for the tenant based on the desired graphical user interface is generated. A tenant data service is processed using the SaaS application. The SaaS application is provided to at least one other tenant in the multi-tenant environment.

### TECHNICAL FIELD

In general, the present invention relates to the field of data processing. Specifically, the present invention relates to software as a service (SaaS) development in a multi-tenant environment.

### BACKGROUND

With the development of network technology, SaaS (software as a service) has become increasingly popular in the Internet field. SaaS is a mode for providing application software through the Internet, in which software providers deploy applications on a server uniformly, and tenants may subscribe desired applications from software providers through the Internet according to their practical demands and obtain applications as provided by software providers through the Internet. Unlike a traditional (on-premise) mode in which software applications are purchased and installed on the customers' computers, in SaaS mode, tenants utilize functions of desired application software by using web-based applications as subscribed from software providers. For example, tenants may utilize the web-based application for customer relationship management, online sales, commodity inventory management, order tracking, and so on.

An advantage of SaaS is that tenants do not need to maintain the software, but software providers are responsible for all work related to management and maintenance of the application. In this case, tenants who rent/utilize SaaS services do not need to purchase, construct, or maintain infrastructure related to traditional applications, and they do not need to have expertise in application software maintenance. They only need to have the ability to utilize the application software.

Compared with on-premise software technology, SaaS boasts a significant difference that the application employs a multi-tenant mode during operation. Multi-tenancy is a model of software architecture. Under this model, only a single instance of the application runs on servers of SaaS providers (i.e., multiple tenants of the application need to share this single instance). Multi-tenancy is relative to single-tenancy. In a single-tenant architecture, one instance of the application only serves one tenant.

Traditional software systems are typically created for a dedicated purpose with limited optional behaviors and features. Major feature and behavior changes to traditional software systems require significant development efforts and the creation of new versions. Systems that are created to be flexible require extensive custom development work to meet custom requirements.

There is a need to provide a system and a method for providing database services that does not have the configurability constraints of a traditional database services. User information technology (IT) environments and the technical requirements widely differ among different organizations. In typical environments, the selection and implementation of database services may impose unnecessary restrictions of alternative implementations and may require additional conversion work. Heretofore, several unsuccessful attempts have been made to address these shortcomings.

U.S. Patent Application 20110179110 discloses a presentation manager configured to provide an interface requesting information regarding a proposal from a digital device over a network and receive the information on the digital device.

U.S. Patent Application 20110126168 discloses a cloud platform for managing software as a service (SaaS) resources which allows customers to consume developed SaaS applications with associated customer data.

U.S. Patent Application 20110010394 discloses client-specific data customization for shared databases in which a client-specific data field identifier for each item of a client-specific data is associated with a first client in a set of clients received at a processor associated with a software as a service (SaaS) module.

U.S. Patent Application 20110191702 discloses a system and method for polymorphic content generation in a multi-application, multi-tenant environment.

U.S. Patent Application 20100332629 discloses a secure custom application which facilitates virtually seamless migration of custom applications to and from a cloud computing environment in response to user needs.

U.S. Patent Application 20090037828 disclose mechanisms and methods for editing an on-demand database service graphical user interface that can enable embodiments to edit desired portions of the interface, in a more flexible manner. The ability of embodiments to provide such additional flexibility may lead to more efficient and effective interface editing.

None of these references, however, teach a method for providing an SaaS that does not have the configurability constraints of a traditional SaaS.

### SUMMARY

Embodiments of the present invention relate to software as a service (SaaS) development in a multi-tenant environment. Specifically, a platform for software as a service (SaaS) application development and customization in a multi-tenant environment is provided. An interface template is defined based on application metadata. Application metadata may comprise and/or be based upon tenant metadata (e.g., via transformation). A desired graphical user interface is rendered based on the interface template. The desired graphical user interface may be edited by the tenant. An SaaS application for the tenant based on the desired graphical user interface is generated. A tenant data service is processed using the SaaS application. The SaaS application is provided to at least one other tenant in the multi-tenant environment.

A first aspect of the present invention provides a computer-implemented method for a providing a platform for software as a service (SaaS) application development and customization in a multi-tenant environment, comprising: defining application data, wherein the application data is associated with tenant business data; generating an interface template based on the application data; rendering a graphical user interface based on the interface template; editing the graphical user interface to create a desired graphical user interface; generating an SaaS application for the tenant based on the desired graphical user interface; and providing the SaaS application to at least one other tenant in the multi-tenant environment.

A second aspect of the present invention provides a platform for software as a service (SaaS) application development and customization in a multi-tenant environment, comprising: a processor that causes the system to: define application data, wherein the application data is associated with tenant business data; generate an interface template based on the application data; render a graphical user interface based on the interface template; edit the graphical user interface to create a desired graphical user interface; generate an SaaS application for the tenant based on the desired graphical user interface; and provide the SaaS application to at least one other tenant in a multi-tenant environment.

A third aspect of the present invention provides a computer program product for providing a platform for software as a service (SaaS) application development and customization in a multi-tenant environment, the computer program product comprising a computer readable storage media, and metadata and program instructions stored on the computer readable storage media, to: define application data, wherein the application data is associated with tenant business data; generate an interface template based on the application data; render a graphical user interface based on the interface template; edit the graphical user interface to create a desired graphical user interface; generate an SaaS application for the tenant based on the desired graphical user interface; and provide the SaaS application to at least one other tenant in a multi-tenant environment.

A fourth aspect of the present invention provides a method for deploying a system for providing a platform for software as a service (SaaS) application development and customization in a multi-tenant environment, comprising: providing a computer infrastructure being operable to: define application data, wherein the application data is associated with tenant business data; generate an interface template based on the application data; render a graphical user interface based on the interface template; edit the graphical user interface to create a desired graphical user interface; generate an SaaS application for the tenant based on the desired graphical user interface; and provide the SaaS application to at least one other tenant in a multi-tenant environment.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a software as a service (SaaS) application development platform according to an embodiment of the present invention.

FIG. 2 depicts a pattern-based graphical user interface schematic according to an embodiment of the present invention.

FIG. 3A depicts a data view screen shot according to an embodiment of the present invention.

FIG. 3B depicts a logical diagram of a data view according to an embodiment of the present invention.

FIG. 4 depicts a graphical user interface method flow diagram according to an embodiment of the present invention.

FIG. 5 depicts a schematic diagram of a query process according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, the like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Generally, the systems and methods disclosed herein include and are implemented within a computer system having one or more databases and other storage apparatuses, servers, and additional components, such as processors, terminals and displays, computer-readable media, algorithms, modules, and other computer-related components. The computer systems are especially configured and adapted to perform the functions and processes of the systems as disclosed herein. As disclosed herein, the systems are illustrated in an exemplary environment in which the systems interact with one or more users directly, indirectly, or through a third party intermediary. A user includes, for example, an end user, an intermediary user, an internet user, an authorized user, etc.

The computing device(s) (e.g., personal computers, smart phones, servers, laptops, and the like) operating with the systems and methods described herein preferably include conventional processors, memory, I/O capabilities and components, and programming modules and/or computer readable media that enable performance of the functions and operation of the system as described herein. The computing device(s) are typically in electronic, bi-directional communication with a client device via a wired or wireless network, for example, the computing device(s) may be networked directly, indirectly, through a third party intermediary, wirelessly, over the Internet, or otherwise with the client device in conventional manner.

Similarly, the database(s) described herein will typically be in electronic, bi-directional communication with the computing device(s) via a wired or wireless network. For example, the database(s) may be networked directly, indirectly, wirelessly, over the Internet, or otherwise with the computing device(s). The database(s) may be implemented in one or more hardware components and may be located locally or remotely from the computing device(s) all in conventional manner.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. There is often a desire to develop various applications for extending capabilities of the aforementioned database systems.

Embodiments of the present invention relate to software as a service (SaaS) development in a multi-tenant environment. Specifically, a platform for software as a service (SaaS) application development and customization in a multi-tenant environment is provided. An interface template is defined based on application metadata. Application metadata may comprise and/or be based upon tenant metadata (e.g., via transformation). A desired graphical user interface is rendered based on the interface template. The desired graphical user interface may be edited by the tenant. An SaaS application for the tenant based on the desired graphical user interface is generated. A tenant data service is processed using the SaaS application. The SaaS application is provided to at least one other tenant in the multi-tenant environment.

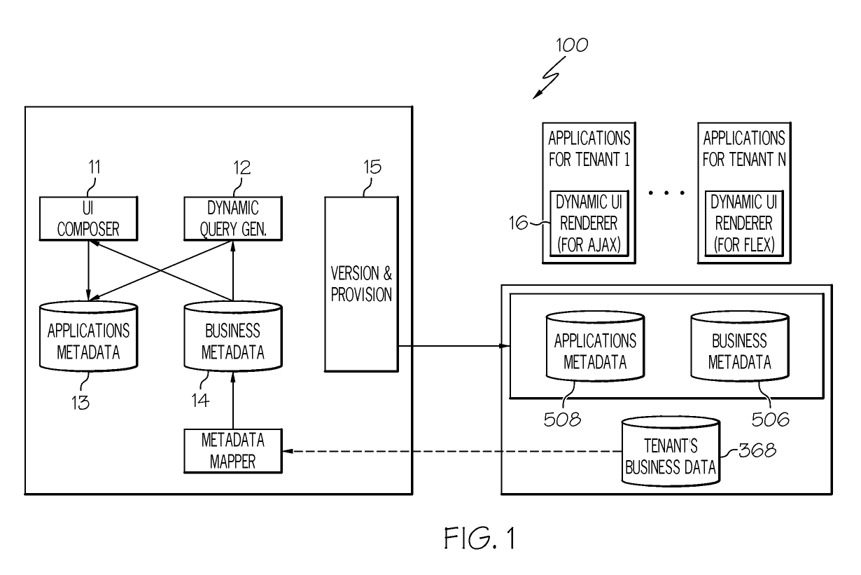

FIG. 1 illustrates an exemplary software as a service (SaaS) application development platform 100 that uses a graphical web user interface for developing, distributing, and performing an SaaS application, in accordance with one embodiment. The application development platform 100 provides development, editing, and publishing tools designed to allow a user to design, create, edit, store, organize, and/or publish an SaaS application for multi-tenant . In the context of the present description, an SaaS application may include any service that relies on a database system or other dataservice that is accessible over a network.

In one example, the SaaS application may include a multi-tenant data service. In the present description, such multi-tenant SaaS application may include any service that relies on a database system or data service that is accessible over a network, in which various elements of hardware and software of the database system may be shared by one or more tenants. A tenant refers to any one or more persons or entities that are capable of accessing the SaaS application in the present description. For example, the tenant(s) may subscribe to the SaaS application.

The SaaS application development platform 100 may include the following SaaS application management components: user interface (UI) composer 11, dynamic query generator 12, applications metadata 13, business metadata 14, version and provision component 15, and a metadata mapper. Other components within the SaaS application development platform 100 may include components associated with one or more tenants. For example, applications for Tenant 1 may include dynamic user interface (UI) renderer 16. Other components are shown in FIG. 1.

It is difficult to create a statically compiled application executable that can meet these and other unique challenges of multi-tenancy. Inherently, a multi-tenant application must be dynamic in nature to fulfill the individual expectations of various tenants and their users.

The SaaS application development platform 100 provides an SaaS application composer (or UI composer) which is used to develop an application for a tenant in a multi-tenant environment. The UI composer 11 generates an interface template based on application data. The interface template may include a pattern, layout, and/or data view. The application data is associated with a tenant's metadata. The application data may comprise and/or be based upon the tenant metadata (e.g., via transformation). The dynamic UI renderer 16 is used to render a graphical user interface based on the application data. The UI composer 11 may be used to edit the graphical user interface to create a desired graphical user interface.

The dynamic query generator 12 may create a query and process a tenant's data service request based on the desired graphical user interface. An SaaS application may be created for the tenant based on the desired graphical user interface. The SaaS application may provide the SaaS application to at least one other tenant in a multi-tenant environment. In one example, the SaaS application may be provided to the other tenants via a provisioning process.

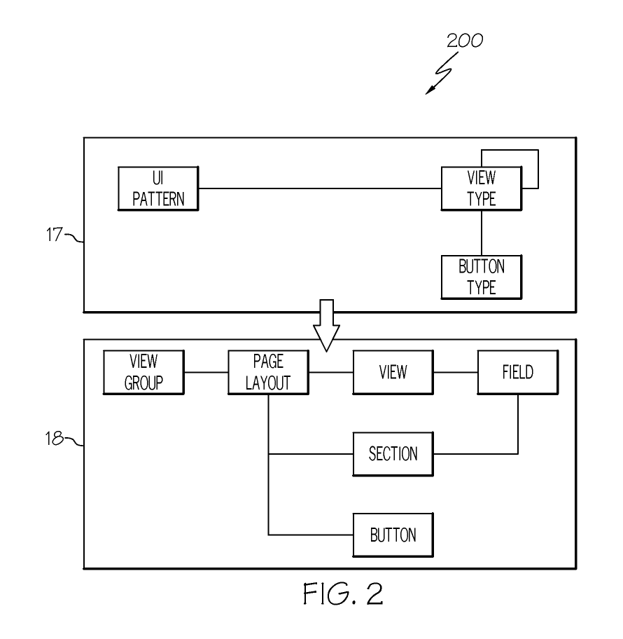

FIG. 2 depicts a pattern-based graphical user interface schematic 200 according to an embodiment of the present invention. The graphical user interface may be based on the respective tenant's data defined by a metadata structure associated with the tenant data. The metadata structure may include different types of the layouts, data views, and data transaction types.

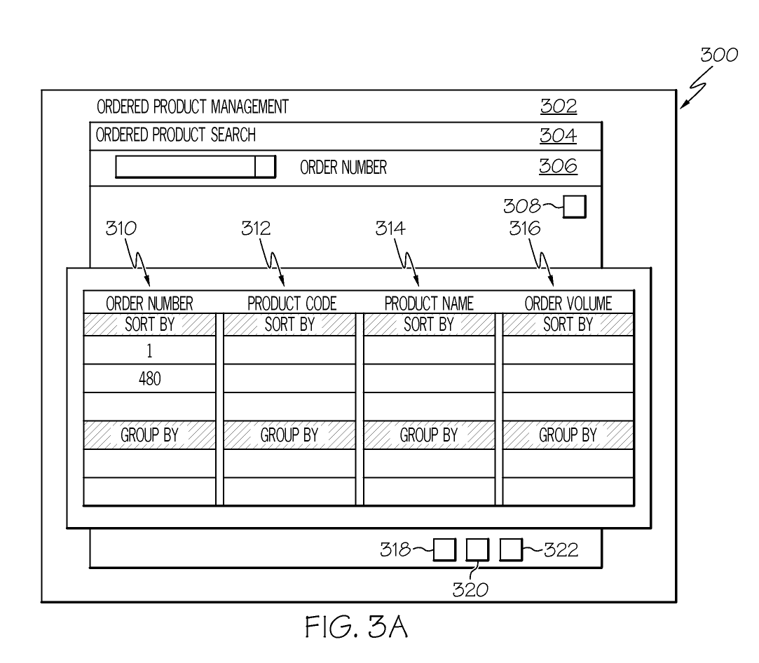

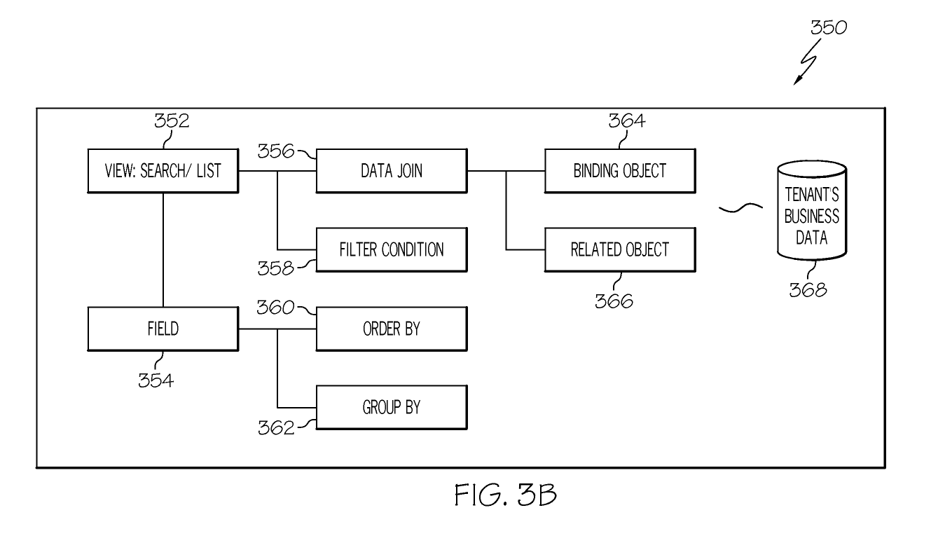

FIG. 3A depicts a data view screen shot 300 according to an embodiment of the present invention. The screen shot 300 depicts ordered product management' interface 302 associated with an example ordered product management database. The screen includes an ordered product search section 304 including order number search 306. A user may enter an order number and click the search/enter button 308. Data related to the searched order number (if found) may be returned and displayed on the screen. The screen further includes columns: order number 310, product code 312, product name 314, and order volume 316. Add 318, update 320, and delete 322 buttons may also be displayed on the screen for database maintenance.

FIG. 3B depicts a logical diagram 350 of a data view according to an embodiment of the present invention. The logical diagram 350 represents a schematic for the ordered product management data shown in FIG. 3A. The logical diagram 350 includes the following: view search/list 352, field 354, data join 356, filter condition 358, order by 360, group by 362, binding object 364, related object 366, and tenant's business data 368.

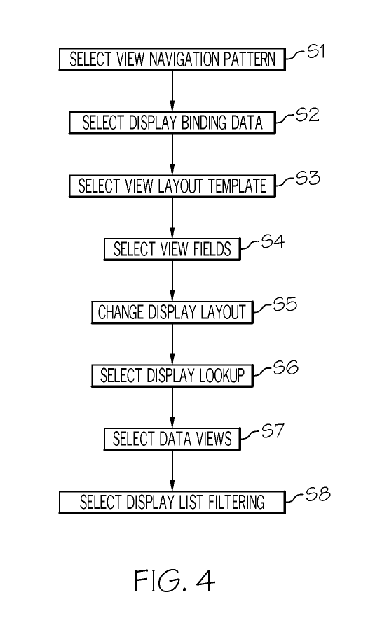

FIG. 4 depicts a graphical user interface method flow diagram according to an embodiment of the present invention. At S1, a view navigation pattern is selected. At S2, a display binding data is selected. At S3, a view layout template is selected. At S4, one or more view fields are selected. At S5, a display layout is changed. At S6, optionally, a display lookup for referencing other data (e.g., master data, etc.) may be selected. At S7, one or more data views are selected. At S8, display list filtering is selected. In certain embodiments, the steps described above may be performed concurrently or in a different order than shown.

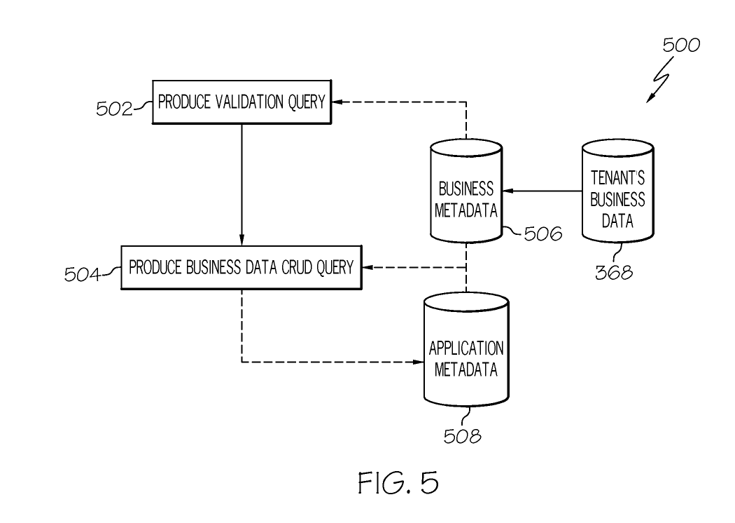

FIG. 5 depicts a schematic diagram of an example query process according to an embodiment of the present invention. The query process includes producing a validation query based on the primary key/foreign key (PK/FK) constraints and uniqueness of the business metadata and input format validation 502. The validation query is produced using business metadata 506, application metadata 508 and tenant's business data 368. In one example, all or a portion of business metadata 506 may be associated with tenant's business data 368. Application metadata 508 may describe an application configuration and application data. Business metadata 506 and application metadata 508 may be used and produced by the processes and procedures of this invention. In the case of business metadata 506, the structure that represents the storage of the metadata may be separate from the structure that represents the storage of the tenant's business data 368. The validation query may validate relationships, unique constraints, and input values. A business data CRUD (create, read, update, and delete) query may be produced based on the business metadata and application metadata 504.

In one example, the query process may be performed in real time. For purposes of the present description, real time shall include any time frame of sufficiently short duration as to provide reasonable response time for information processing acceptable to a user of the subject matter described. Additionally, the term “real time” shall include what is commonly termed “near real time” which generally means any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

While shown and described herein as an SaaS application solution in multi-tenancy, it is understood that the invention further provides various alternative embodiments. For example, in one embodiment, the invention provides a computer-readable/useable medium that includes computer program code to enable a computer infrastructure to provide SaaS application generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.).

In still another embodiment, the invention provides a computer-implemented method for generating an SaaS application in a multi-tenant environment. In this case, a computer infrastructure, such as SaaS application development platform 100 (FIG. 1), can be provided, and one or more systems for performing the processes of the invention can be obtained (e.g., created, purchased, used, modified, etc.) and deployed to the computer infrastructure. To this extent, the deployment of a system can comprise one or more of: (1) installing program code on a computing device, from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage for metadata in order to reduce traffic and time in retrieving metadata that is retrieved from bulk storage during execution.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for a providing a platform for software as a service (SaaS) application development and customization in a multi-tenant environment, comprising:
defining application data, wherein the application data is associated with tenant business data;
generating an interface template based on the application data;
rendering a graphical user interface based on the interface template;
editing the graphical user interface to create a desired graphical user interface;
generating an SaaS application for the tenant based on the desired graphical user interface; and
providing the SaaS application to at least one other tenant in the multi-tenant environment.

2. The computer-implemented method of claim 1, wherein the application data comprises application metadata.

3. The computer-implemented method of claim 1, wherein the application metadata and business metadata are stored separately.

4. The computer-implemented method of claim 1, wherein the SaaS application is provided to at least one other tenant in the multi-tenant environment via a provisioning process.

5. The computer-implemented method of claim 1, further comprising dynamically generating a query based on the graphical user interface.

6. The computer-implemented method of claim 1, wherein the interface template comprises at least one of an editable pattern, editable layout or editable data view.

7. A platform for software as a service (SaaS) application development and customization in a multi-tenant environment, comprising:
a processor that causes the system to:
define application data, wherein the application data is associated with tenant business data;
generate an interface template based on the application data;
render a graphical user interface based on the interface template;
edit the graphical user interface to create a desired graphical user interface;
generate an SaaS application for the tenant based on the desired graphical user interface; and
provide the SaaS application to at least one other tenant in a multi-tenant environment.

8. The platform of claim 7, wherein the application data comprises application metadata.

9. The platform of claim 7, wherein the application metadata and business metadata are stored separately.

10. The platform of claim 7, wherein the SaaS application is provided to at least one other tenant in the multi-tenant environment via a provisioning process.

11. The platform of claim 7, the processor further causing the system to dynamically generate a query based on the graphical user interface.

12. The platform of claim 7, wherein the interface template comprises at least one of an editable pattern, editable layout or editable data view.

13. A computer program product for providing a platform for software as a service (SaaS) application development and customization in a multi-tenant environment, the computer program product comprising a computer readable storage media, and metadata and program instructions stored on the computer readable storage media, to:
define application data, wherein the application data is associated with tenant business data;
generate an interface template based on the application data;
render a graphical user interface based on the interface template;
edit the graphical user interface to create a desired graphical user interface;
generate an SaaS application for the tenant based on the desired graphical user interface; and
provide the SaaS application to at least one other tenant in a multi-tenant environment.

14. The computer program product of claim 13, wherein the application data comprises application metadata.

15. The computer program product of claim 13, wherein the application metadata and business metadata are stored separately.

16. The computer program product of claim 13, wherein the SaaS application is provided to at least one other tenant in the multi-tenant environment via a provisioning process.

17. The computer program product of claim 13, the computer readable storage medium further comprising instructions to dynamically generate a query based on the graphical user interface.

18. The computer program product of claim 13, wherein the interface template comprises at least one of an editable pattern, editable layout or editable data view.

19. A method for deploying a system for providing a platform for software as a service (SaaS) application development and customization in a multi-tenant environment, comprising:
providing a computer infrastructure being operable to:
define application data, wherein the application data is associated with tenant business data;
generate an interface template based on the application data;
render a graphical user interface based on the interface template;
edit the graphical user interface to create a desired graphical user interface;
generate an SaaS application for the tenant based on the desired graphical user interface; and
provide the SaaS application to at least one other tenant in a multi-tenant environment.

20. The method of claim 19, wherein the application data comprises application metadata.
